(19) United States
(12) Patent Application Publication
(10) Pub. No.: US 2015/0201338 A1
(43) Pub. Date: Jul. 16, 2015

(54) CONFIGURING MEASUREMENT GAP GROUPS FOR WIRELESS SYSTEMS

(71) Applicant: QUALCOMM Incorporated, San Diego, CA (US)

(72) Inventors: Thawatt GOPAL, San Diego, CA (US); Reza SHAHIDI, San Diego, CA (US); Kuo-Chun LEE, San Diego, CA (US); Tom CHIN, San Diego, CA (US)

(73) Assignee: QUALCOMM Incorporated, San Diego, CA (US)

(21) Appl. No.: 14/154,041

(22) Filed: Jan. 13, 2014

(51) Int. Cl. H04W 24/08; H04W 72/04; H04L 5/00

(52) U.S. Cl. CPC H04W 24/08; H04L 5/005; H04W 72/0446

(57) ABSTRACT

A base station may allocate served user equipments (UEs) into measurement gap groups, which are configured to reduce the overlap between UE measurement gaps used for inter-RAT measurement. The base station may configure the measurement gap groups based on an offset between subframes of a served and measured RAT and may distribute UEs in the measurement gap groups to avoid overlapping inter-RAT measurement times, thereby reducing idle base station resources.

### BACKGROUND

1. Field

Aspects of the present disclosure relate generally to wireless communication systems, and more particularly, to configuring inter-radio access technology (IRAT) measurement gap groups for user equipments (UEs).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

Offered is a method of wireless communication. The method includes determining a periodicity of pilot signals of a non-serving radio access technology (RAT). The method also includes determining a time offset between a subframe of a serving RAT and a pilot signal of the non-serving RAT based at least in part on the periodicity. The method further includes determining measurement gap groups for user equipments (UEs) to measure the pilot signals of the non-serving RAT based at least in part on the time offset. The method still further includes allocating UEs to measurement gap groups.

Offered is an apparatus for wireless communication. The apparatus includes means for determining a periodicity of pilot signals of a non-serving radio access technology (RAT). The apparatus also includes means for determining a time offset between a subframe of a serving RAT and a pilot signal of the non-serving RAT based at least in part on the periodicity. The apparatus further includes means for determining measurement gap groups for user equipments (UEs) to measure the pilot signals of the non-serving RAT based at least in part on the time offset. The apparatus still further includes means for allocating UEs to measurement gap groups.

Offered is a computer program product configured for wireless communication. The computer program produce includes a non-transitory computer-readable storage program code recorded thereon. The program code includes program code to determine a periodicity of pilot signals of a non-serving radio access technology (RAT). The program code also includes program code to determine a time offset between a subframe of a serving RAT and a pilot signal of the non-serving RAT based at least in part on the periodicity. The program code further includes program code to determine measurement gap groups for user equipments (UEs) to measure the pilot signals of the non-serving RAT based at least in part on the time offset. The program code still further includes program code to allocate UEs to measurement gap groups.

Offered is an apparatus for wireless communication. The apparatus includes a memory and a processor(s) coupled to the memory. The processor(s) is configured to determine a periodicity of pilot signals of a non-serving radio access technology (RAT). The processor(s) is also configured to determine a time offset between a subframe of a serving RAT and a pilot signal of the non-serving RAT based at least in part on the periodicity. The processor(s) is further configured to determine measurement gap groups for user equipments (UEs) to measure the pilot signals of the non-serving RAT based at least in part on the time offset. The processor(s) is still further configured to allocate UEs to measurement gap groups.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a block diagram conceptually illustrating an example of a frame structure in a TD-SCDMA telecommunications system.

FIG. 8 is an example of an LTE timeline alongside a TD-SCDMA timeline.

FIG. 9 is a diagram illustrating configuration of measurement gap groups according to one aspect of the present disclosure.

FIG. 10 is a block diagram illustrating allocating UEs to measurement gap groups according to one aspect of the present disclosure.

FIG. 11 is a diagram illustrating an example of a hardware implementation for an apparatus employing a processing system according to one aspect of the present disclosure

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

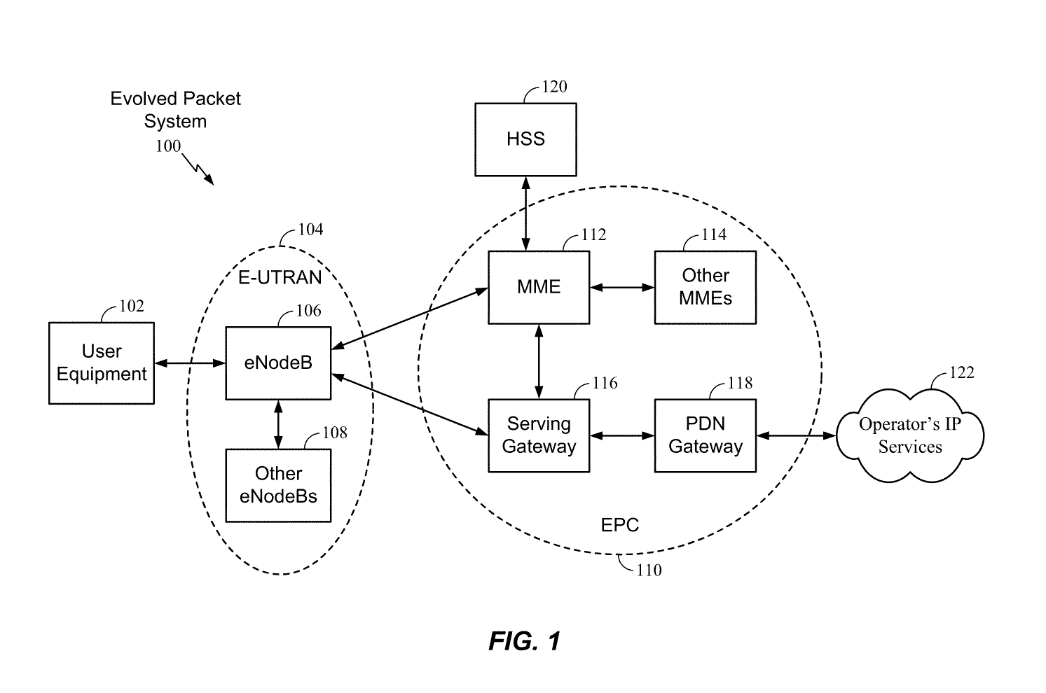

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

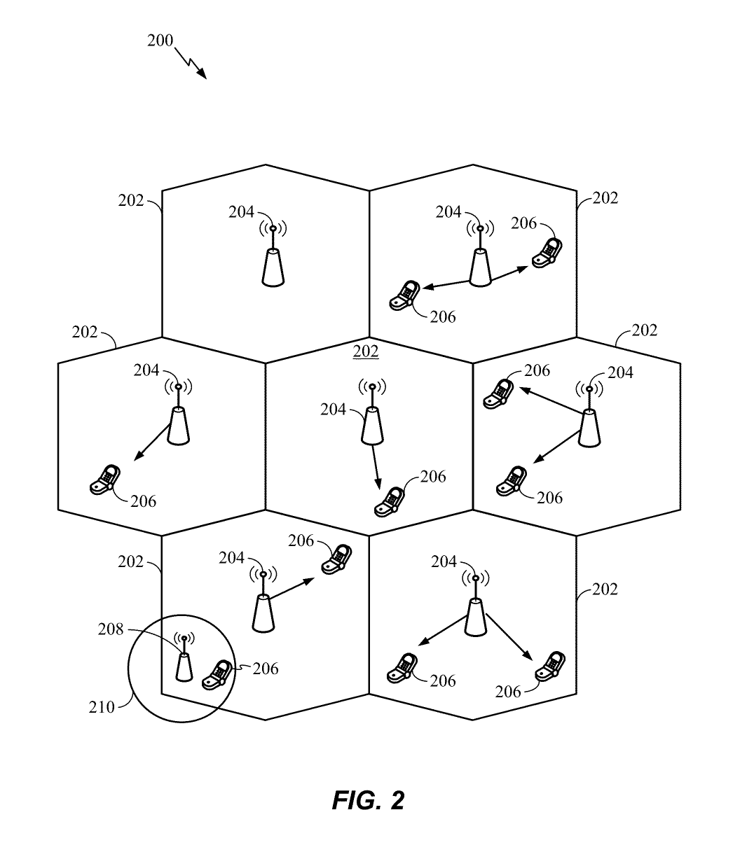

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

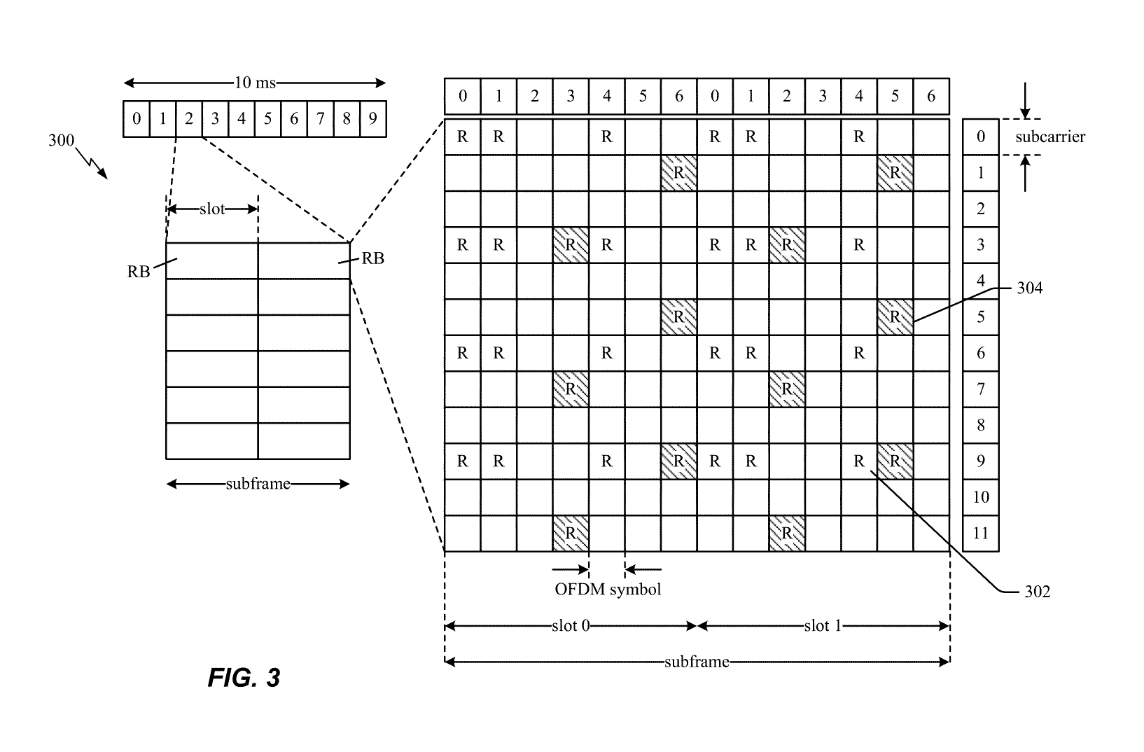

FIG. 3 is a diagram 300 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

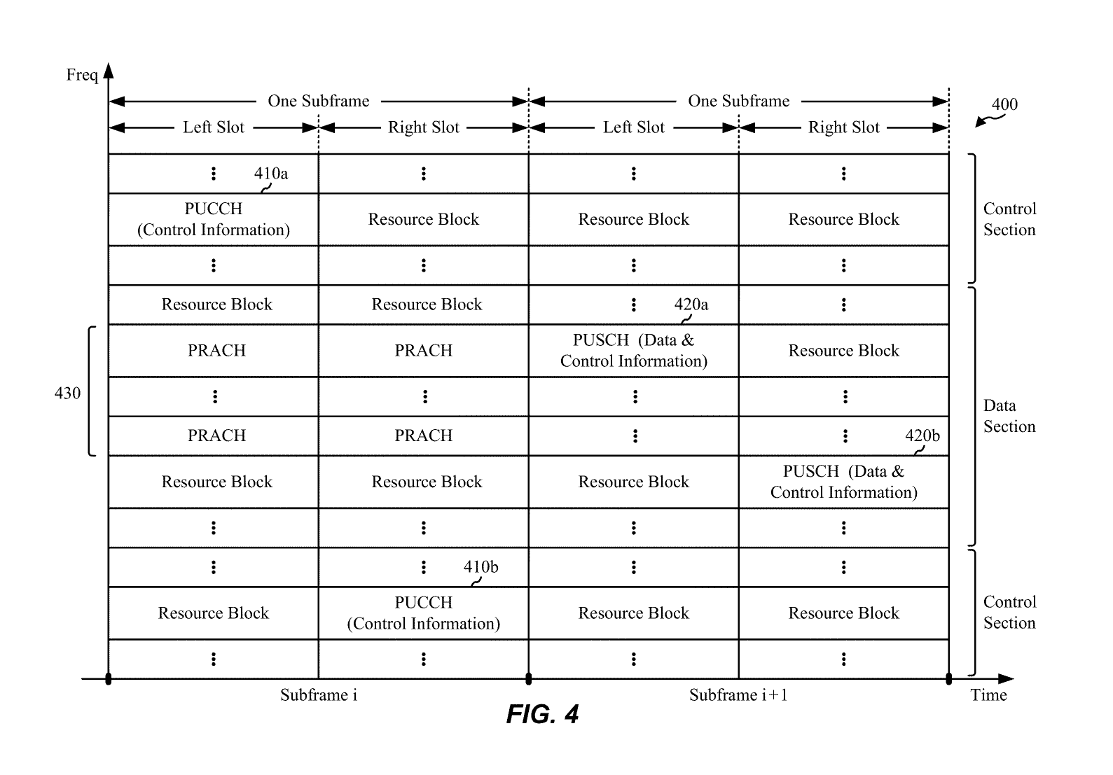

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

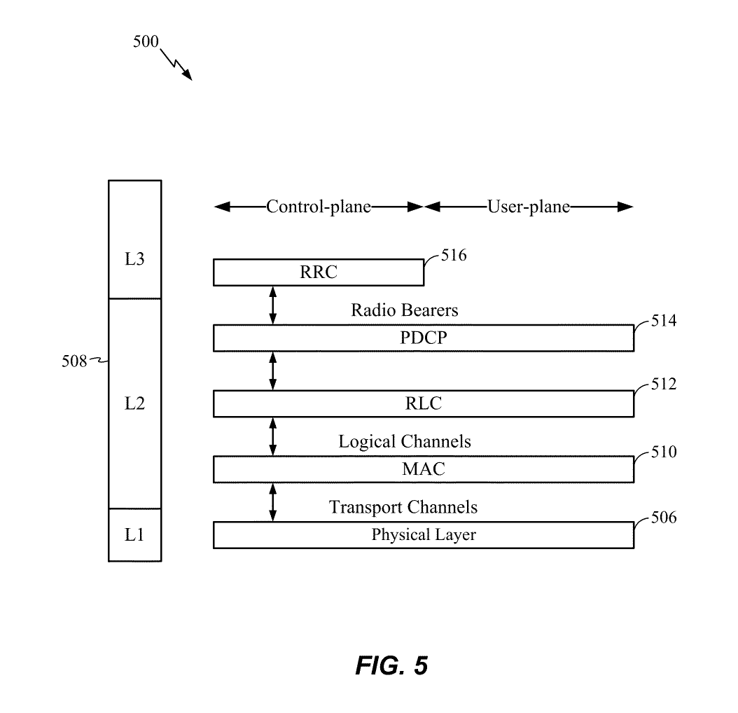

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

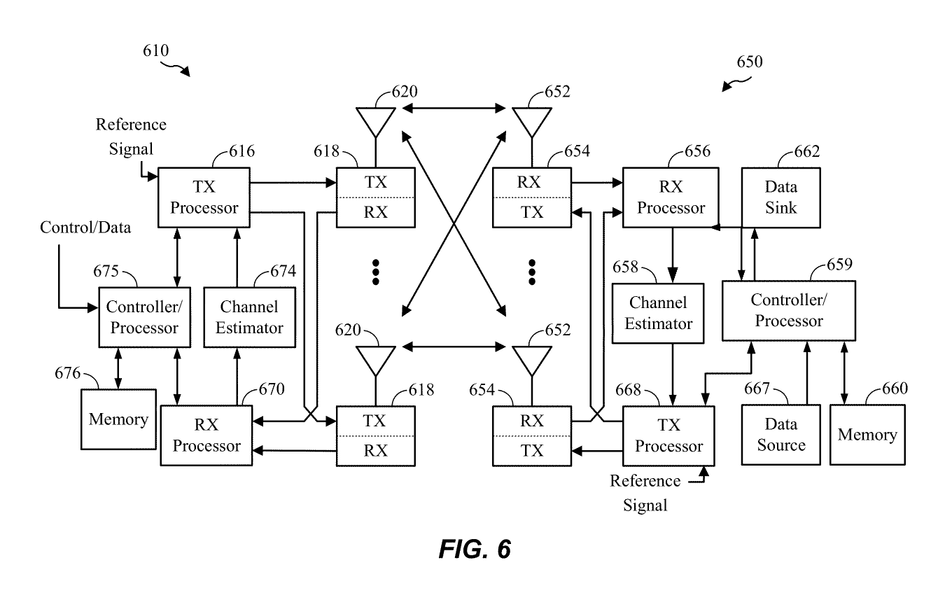

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

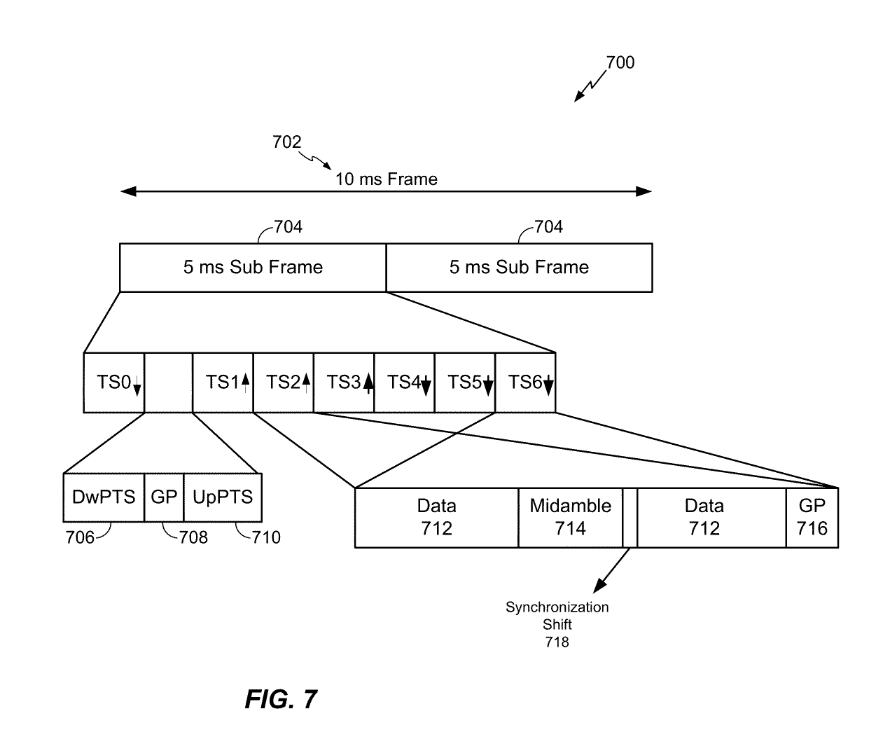

While LTE communications may be configured in a system as described above, other wireless communication systems may be configured differently. For example, a UMTS system employing a TD-SCDMA standard may configure its equipment and communications differently from an LTE system. For example, a TD-SCDMA system is time synchronous, meaning all TD-SCDMA communications are aligned in time. A TD-SCDMA frame structure is illustrated in FIG. 7.

FIG. 7 shows a frame structure 700 for a TD-SCDMA carrier. The TD-SCDMA carrier, as illustrated, has a frame 702 that is 10 ms in length. The chip rate in TD-SCDMA is 1.28 Mcps. The frame 702 has two 5 ms subframes 704, and each of the subframes 704 includes seven time slots, TS0 through TS6. Each time slot is 675 μs long. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A special timeslot include a downlink pilot time slot (DwPTS) 706 (96 chips long), a guard period (GP) 708 (96 chips long), and an uplink pilot time slot (UpPTS) 710 (also known as the uplink pilot channel (UpPCH)) (160 chips long) is located between TS0 and TS1. Each time slot, TS0-TS6, may allow data transmission multiplexed on a maximum of 16 code channels. Data transmission on a code channel includes two data portions 712 (each with a length of 352 chips) separated by a midamble 714 (with a length of 144 chips) and followed by a guard period (GP) 716 (with a length of 16 chips). The midamble 714 may be used for features, such as channel estimation, while the guard period 716 may be used to avoid inter-burst interference. Also transmitted in the data portion is some Layer 1 control information, including Synchronization Shift (SS) bits 718. Synchronization Shift bits 718 only appear in the second part of the data portion. The Synchronization Shift bits 718 immediately following the midamble can indicate three cases: decrease shift, increase shift, or do nothing in the upload transmit timing. The positions of the SS bits 718 are not generally used during uplink communications.

### Configuring Measurement Gap Groups

When a UE operating in LTE desires to perform measurement of a neighboring communication network operating a different radio access technology (RAT) (called inter-RAT measurement) the UE temporarily tunes to the other RAT to measure the available signal and then retunes to LTE to resume LTE communications. Inter-RAT measurement typically involves the UE listening for the pilot and other control signals of the neighbor RAT. LTE communications indicate that a gap period for a UE to perform inter-RAT measurement should be 6 ms long, meaning the UE typically ceases communications with its serving LTE eNodeB for those 6 ms while the UE performs the inter-RAT measurement of the neighboring RAT. During those 6 ms, the communication resources of the serving LTE eNodeB that would otherwise be allocated to the measuring UE become idle. This is because while the UE is performing inter-RAT measurement, the UE is no longer listening to the serving LTE eNodeB, thus temporarily suspending communications with the serving LTE eNodeB. If a particular eNodeB is serving multiple UEs that simultaneously perform inter-RAT measurement, this increases the number of idle resources of that particular eNodeB, thus leading to inefficient operation of the eNodeB. Further, present LTE scheduling of a measurement gap likely does not take into account the properties of the RAT to be measured.

Offered is a method and system for configuring UEs to perform inter-RAT measurement from one RAT to another that reduces the idle air interface radio resources for the serving base station of the measuring UE. Although in the examples discussed below the serving RAT is LTE and the measured RAT is TD-SCDMA, the present teachings may be applied to numerous other serving RAT/measured RAT combinations.

Many UEs are single baseband processor/transceiver UEs, which means the UE is capable of communicating with only one RAT at a time, meaning the UE stops communicating with one RAT before it begins communications with another RAT. Thus, in order to perform inter-RAT measurement, the UE tunes away from its serving RAT to measure the neighbor RAT. As noted above, when an LTE eNodeB schedules its served UEs for inter-RAT measurement the eNodeB schedules a 6 ms measurement gap for the UE during which the UE will cease communication with the LTE eNodeB and instead search for and measure the neighboring RAT. This results in air interface radio resources being allocated to the UE being used for inter RAT measurement rather than used for communication with the eNodeB. It is advantageous for the eNodeB to space out the measurement gaps of its served UEs to reduce any idle air interface radio resources of the eNodeB. This typically applies for UEs in connected mode, as UEs in idle mode are not generally assigned eNodeB air interface radio resources that would be allocated to the idle UE but would be unused.

Further, inter-RAT measurements of a TD-SCDMA RAT, are typically based on a receive signal code power (RSCP) measurement of the TD-SCDMA primary common control physical channel (PCCPCH), which is sent during time slot 0 (TS0) of the TD-SCDMA subframe. Inter-RAT measurements of TD-SCDMA also typically include receiving of the TD-SCDMA cell ID, located in the midamble of TS0, as well as the DwPTS of the TD-SCDMA special time slot. The duration of a TD-SCDMA time-slot is 675 μs, the duration of a TD-SCDMA subframe is 5 ms, and the duration of TD-SCDMA radio-frame is 10 ms. As the signals for TD-SCDMA pilot measurement repeat every subframe, the LTE measurement gap of 6 ms is typically sufficient to perform TD-SCDMA inter-RAT measurement, if properly scheduled.

The following describes a method to properly schedule LTE measurement gaps for multiple served UEs to measure a TD-SCDMA signal, while also reducing the number of served UEs measuring at the same time. An LTE eNodeB (or network controller, etc.) determines a time offset between LTE communications and TD-SCDMA communications. The eNodeB then schedules repeating measurement gap time periods based on the offset, to make sure the measurement gap time periods cover the pilot and other measurement targets of the TD-SCDMA communications. The LTE eNodeB next allocates UEs in groups to the measurement gap time periods, alternating UE allocation to reduce overlap between UE measurement gaps.

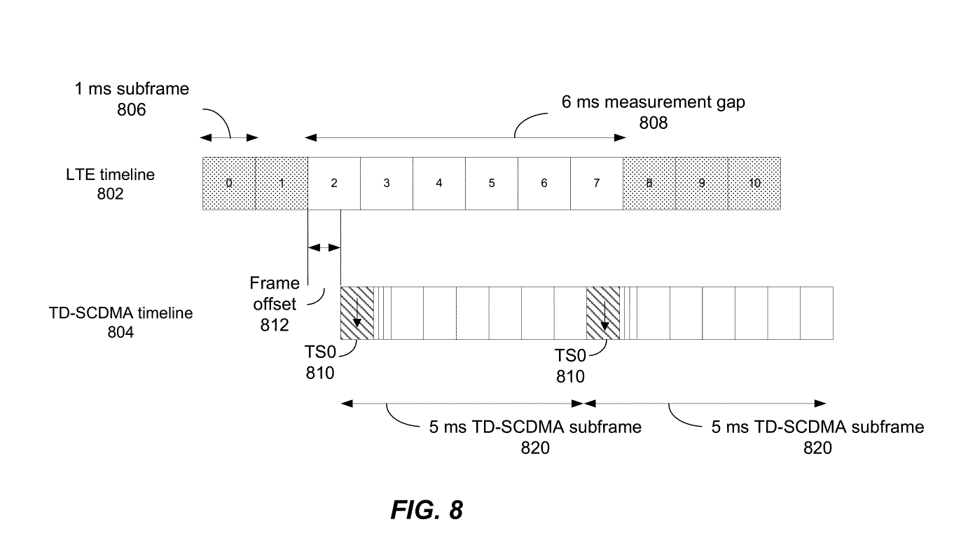

To determine the offset between communications of the serving RAT (e.g., LTE) and the RAT to be measured (e.g., TD-SCDMA), the eNodeB determines the offset between the beginning of the TD-SCDMA TS0 and the closest LTE subframe that begins prior to the TD-SCDMA TS0. This process is shown in FIG. 8. FIG. 8 illustrates an LTE timeline 802 having multiple 1 ms subframes, 806. Also shown is a TD-SCDMA timeline 804 showing two 5 ms TD-SCDMA subframes 820, with each TD-SCDMA subframe beginning with a TS0 810. To schedule a 6 ms LTE measurement gap 808 to ensure sufficient overlap with the measurement pilot signal targets in the TD-SCDMA TS0 and special subframe, the LTE eNodeB identifies the TS0 of the TD-SCDMA timeline that is closest to the beginning of the LTE timeline (i.e., the beginning of the LTE periodicity, represented by LTE subframe 0). The eNodeB then determines the frame offset 812 between the beginning of the TD-SCDMA TS0 and the beginning of the closest LTE subframe that overlaps with the TS0. As the TD-SCDMA subframe (and pilot signals) repeat every 5 ms, the frame offset 812 may be used by the LTE eNodeB to identify when the beginning of each TD-SCDMA TS0 (and when the pilot signals) repeat relative to the LTE timeline 802. The LTE eNodeB may obtain the TD-SCDMA timing from TD-SCDMA TS0 measurements made by a UE in communication with the LTE eNodeB. The eNodeB may then compute the relative timing offset from these measurements. Other techniques for obtaining TD-SCDMA timing may also be used.

As noted above, certain UEs have only a single transceiver, which means a UE tunes away from LTE to a new frequency in order to perform inter-RAT measurement. The time it takes for a UE to tune from the LTE frequency to the frequency of the RAT (including both reconfiguring RF components and switching the baseband processing) as to be measured may be referred to as a measurement time, Δₘ. Δₘ may vary from UE to UE, however the LTE specification may dictate a floor measurement time that compliant UEs should adhere to. This floor measurement time (which may be approximately 0.5 ms) may be used by the LTE eNodeB as a common Δₘ for present purposes.

Referring again to FIG. 8, if the frame offset 812 is greater than Δₘ, the eNodeB may schedule a measurement gap to begin with the LTE subframe that overlaps TS0. If the frame offset 812 is less than Δₘ, the eNodeB may schedule the measurement gap to begin with the LTE subframe prior to the subframe that overlaps with TS0.

Once the eNodeB has identified the LTE subframe that will begin an LTE measurement gap, the eNodeB may determine other locations for measurement gaps based on the periodicity of the LTE timeline. The eNodeB may then group individual UEs into the measurement gaps as described later.

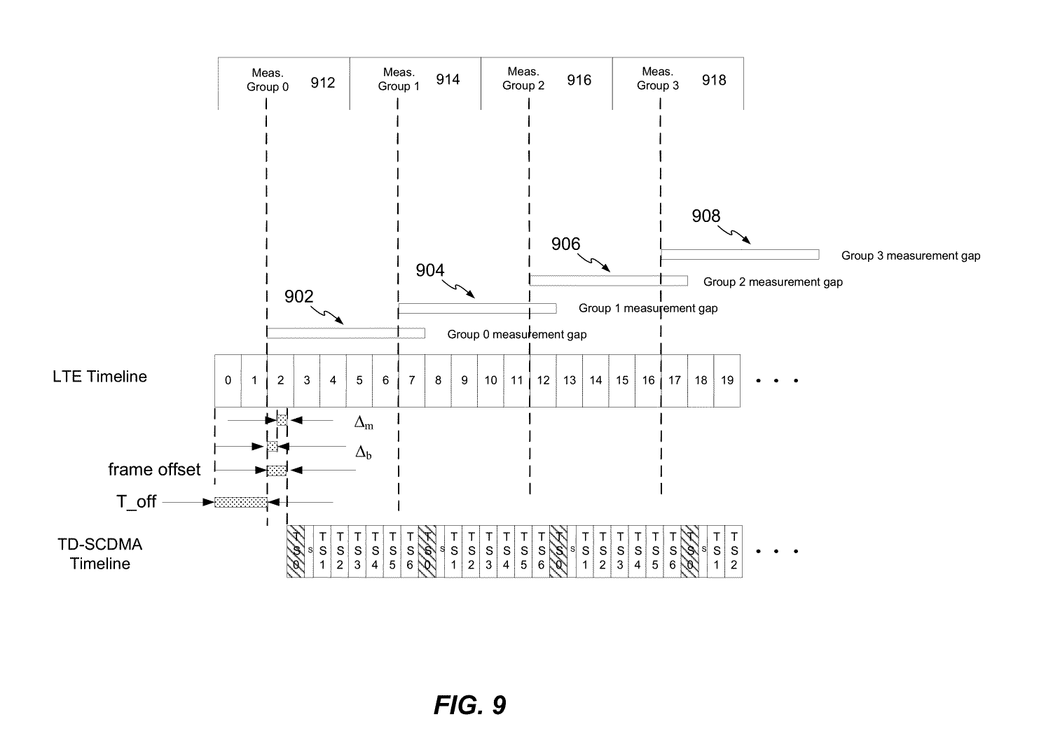

FIG. 9 illustrates an extended LTE timeline alongside the TD-SCDMA timeline. As discussed, the eNodeB identifies the TD-SCDMA TS0 that is closest to the beginning of the repeating LTE timeline, as represented by LTE subframe 0. The eNodeB then determines the frame offset between the beginning of TS0 and the beginning of the nearest LTE subframe that overlaps TS0, which in the example illustrated in FIG. 9 is LTE subframe 2. The length of the frame offset is measurement time Δₘ plus Δ_{b}, which represents an amount of time between the boundary of the LTE subframe (i.e., the boundary between LTE subframes 1 and 2) and the edge of Δₘ, as shown in FIG. 9.

To ensure that the measurement gap of a served LTE UE will overlap with the pilots of the TD-SCDMA signal, the eNodeB will schedule the first 6 ms measurement gap 902 to begin at the beginning of LTE subframe 2. The timeline offset between the beginning of the LTE timeline and the first measurement gap is illustrated in FIG. 9 as T_off. To eventually evenly distribute the UEs for inter-RAT measurement, the eNodeB will continue to configure different measurement gaps along the LTE timeline. If the LTE timeline has a periodicity of 40 ms, 8 measurement gaps (numbering gaps 0 through 7) may be configured. If the LTE timeline has a periodicity of 80 ms, 16 measurement gaps (numbering gaps 0 through 15) may be configured. As shown in FIG. 9, a measurement gap will be configured to begin every 5 ms after the T_off. Measurement gap 0 is indicated by arrow 902, measurement gap 1 is indicated by arrow 904, measurement gap 3 is indicated by arrow 906 and measurement gap 4 is indicated by arrow 908. The measurement gaps then continue for the remainder of the LTE timeline (not pictured).

Each measurement gap is associated with a measurement gap group. A measurement gap group is a 5 ms section of the LTE timeline during which the corresponding measurement gap begins. For example, measurement gap group 0 (912) corresponds to measurement gap 0 (902), measurement gap group 1 (914) corresponds to measurement gap 1 (904), measurement gap group 2 (916) corresponds to measurement gap 2 (906), measurement gap group 3 (918) corresponds to measurement gap 3 (908), and so on for the un-illustrated gaps and gap groups.

As the measurement gaps themselves (at 6 ms long) are longer than their corresponding measurement gap groups (at 5 ms long), there will be some overlap between measurement gaps. This overlap is illustrated in FIG. 9, as subframes 7, 12, 17, etc. will all experience overlapping measurement gaps.

To reduce the number of UEs that simultaneously perform inter-RAT measurement the eNodeB may reduce the number of UEs scheduled for inter-RAT measurement during the subframes with overlapping measurement gaps, which in turn means reducing the number of UEs scheduled in adjacent measurement gap groups. To do this, the eNodeB will spread out the assignment of served UEs among alternating measurement gap groups. For example, the eNodeB may first assign UEs to even numbered gap groups (0, 2, 4, etc.). Once one UE is assigned to each even numbered measurement gap group in the LTE timeline (i.e., a 40 ms timeline or 80 ms timeline), the eNodeB will begin scheduling UEs into the odd numbered measurement gap groups (1, 3, 5, etc.). If the odd numbered gap groups then become full the eNodeB may assign a second round of UEs to the even numbered groups, and so on. Similarly, the eNodeB may start assigning UEs to odd numbered measurement gap groups before moving to even numbered gap groups. In this manner, the eNodeB will reduce the number of UEs assigned to perform inter-RAT measurement at overlapping times, thus correspondingly reducing the amount of eNodeB resources assigned to UEs performing inter-RAT measurement (thus rendering the eNodeB resources idle during the respective inter-RAT measurement periods).

Each UE will receive its configuration and instruction from the eNodeB regarding when each respective UE is to perform inter-RAT measurement (along with other traditional inter-RAT measurement instructions, such as target RAT information, etc.) A UE will then tune to the target RAT and perform inter-RAT measurement (which includes measuring pilot signals, performing signal correlation, channel estimation, and signal strength/quality measurements) during its assigned measurement gap. The UE re-tunes to LTE following inter-RAT measurement, and sends the appropriate measurement report to the original serving base station (i.e., LTE eNodeB).

An eNodeB may only assign UEs that are in connected mode to measurement gap groups, as idle UEs typically are not allocated eNodeB resources in the same manner as connected UEs. UEs that leave the connected state with the eNodeB may leave a vacancy in the respective measurement gap group. To account for UEs disconnecting in this manner, the eNodeB may track UEs that break their connections along with the measurement gap group assignments of those UEs. The eNodeB may then assign new UEs (such as those who hand off to the eNodeB or begin new connections) to the vacated measurement gap group assignments.

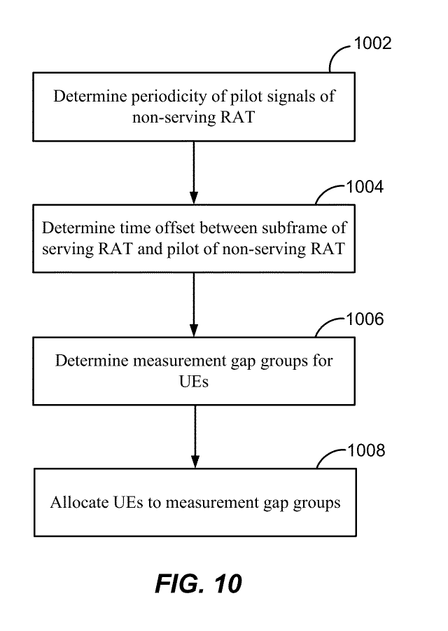

FIG. 10 shows a wireless communication method according to one aspect of the disclosure. A device may determine a periodicity of pilot signals of a non-serving radio access technology (RAT), as shown in block 1002. The device may determine a time offset between a subframe of a serving RAT and a pilot signal of the non-serving RAT based on the periodicity, as shown in block 1004. The device may determine measurement gap groups for user equipments (UEs) to measure the pilot signals of the non-serving RAT based on the time offset, as shown in block 1006. The device may also allocate UEs to measurement gap groups, as shown in block 1008.

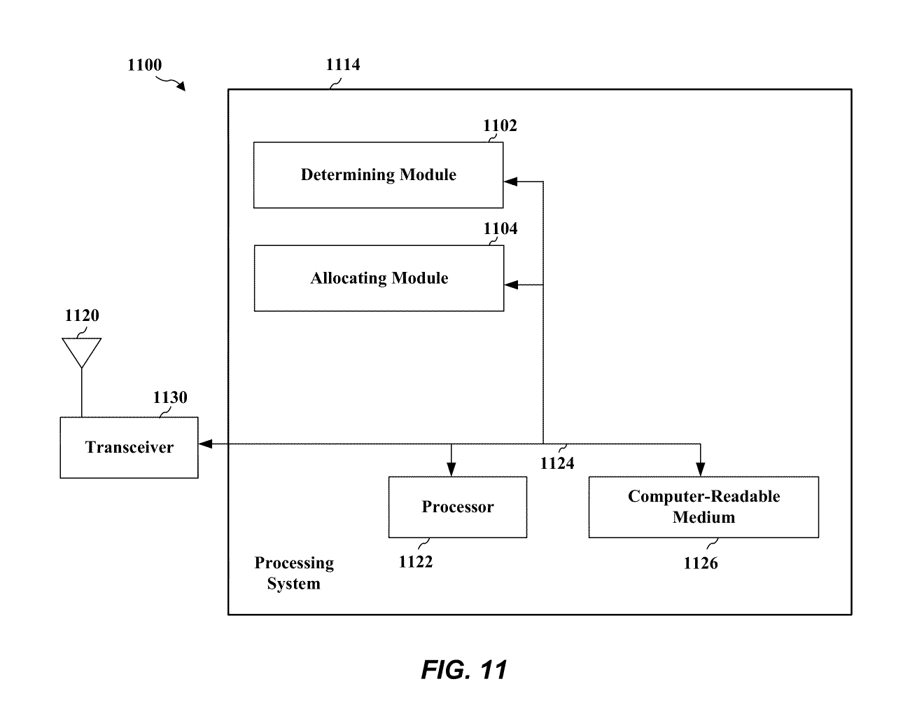

FIG. 11 is a diagram illustrating an example of a hardware implementation for an apparatus 1100 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122, the modules 1102 and 1104, and the computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a determining module 1102. The determining module may determine the periodicity of pilot signals of a non-serving RAT, determine the time offset between a subframe of a serving RAT and the pilot signals of the non-serving RAT and/or determine measurement gap groups for served UEs. The processing system 1114 also includes an allocating module 1104 for allocating UEs to measurement gap groups. The modules may be software module(s) running in the processor 1122, resident/stored in the computer-readable medium 1126, one or more hardware modules coupled to the processor 1122, or some combination thereof. The processing system 1114 may be a component of the eNodeB 610 and may include the memory 676, and/or the controller/processor 675.

In one configuration, an apparatus such as an eNodeB is configured for wireless communication including means for determining. In one aspect, the above means may be the controller/processor 675, the memory 676, antenna 620, receiver 618RX, reference signal, determining module 1102, and/or the processing system 1114 configured to perform the functions recited by the aforementioned means. In another aspect, the aforementioned means may be a module or any apparatus configured to perform the functions recited by the aforementioned means.

In one configuration, an apparatus such as an eNodeB is configured for wireless communication including means for allocating. In one aspect, the above means may be the controller/processor 675, the memory 676, antenna 620, allocating module 1104, and/or the processing system 1114 configured to perform the functions recited by the aforementioned means. In another aspect, the aforementioned means may be a module or any apparatus configured to perform the functions recited by the aforementioned means.

Several aspects of a telecommunications system has been presented with reference to LTE and TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, the method comprising:
determining a periodicity of pilot signals of a non-serving radio access technology (RAT);
determining a time offset between a subframe of a serving RAT and a pilot signal of the non-serving RAT based at least in part on the periodicity;
determining measurement gap groups for user equipments (UEs) to measure the pilot signals of the non-serving RAT based at least in part on the time offset; and
allocating UEs to measurement gap groups.

2. The method of claim 1, further comprising:
dividing the measurement gap groups into even numbered groups and odd numbered groups; and
allocating UEs to alternating measurement gap groups starting with the even numbered groups.

3. The method of claim 1, in which determining the measurement gap groups is further based on the measurement gap periodicity of the serving RAT.

4. The method of claim 1, further comprising aligning measurement gap groups with subframe boundaries of the serving RAT.

5. The method of claim 4, in which aligning the measurement gap groups is further based at least in part on a time for a UE to tune from the serving RAT to the non-serving RAT.

6. An apparatus for wireless communication, comprising:
means for determining a periodicity of pilot signals of a non-serving radio access technology (RAT);
means for determining a time offset between a subframe of a serving RAT and a pilot signal of the non-serving RAT based at least in part on the periodicity;
means for determining measurement gap groups for user equipments (UEs) to measure the pilot signals of the non-serving RAT based at least in part on the time offset; and
means for allocating UEs to measurement gap groups.

7. The apparatus of claim 6, further comprising:
means for dividing the measurement gap groups into even numbered groups and odd numbered groups; and
means for allocating UEs to alternating measurement gap groups starting with the even numbered groups.

8. The apparatus of claim 6, in which the means for determining the measurement gap groups is further based on the measurement gap periodicity of the serving RAT.

9. The apparatus of claim 6, further comprising means for aligning measurement gap groups with subframe boundaries of the serving RAT.

10. The apparatus of claim 9, in which the means for aligning the measurement gap groups is further based at least in part on a time for a UE to tune from the serving RAT to the non-serving RAT.

11. A computer program product configured for wireless communication, the computer program product comprising:
a non-transitory computer-readable storage program code recorded thereon, the program code comprising:
program code to determine a periodicity of pilot signals of a non-serving radio access technology (RAT);
program code to determine a time offset between a subframe of a serving RAT and a pilot signal of the non-serving RAT based at least in part on the periodicity;
program code to determine measurement gap groups for user equipments (UEs) to measure the pilot signals of the non-serving RAT based at least in part on the time offset; and
program code to allocate UEs to measurement gap groups.

12. The computer program product of claim 11, further comprising:
program code to divide the measurement gap groups into even numbered groups and odd numbered groups; and
program code to allocate UEs to alternating measurement gap groups starting with the even numbered groups.

13. The computer program product of claim 11, in which the program code to determine the measurement gap groups is further based on the measurement gap periodicity of the serving RAT.

14. The computer program product of claim 11, further comprising program code to align measurement gap groups with subframe boundaries of the serving RAT.

15. The computer program product of claim 14, in which program code to align the measurement gap groups is further based at least in part on a time for a UE to tune from the serving RAT to the non-serving RAT.

16. An apparatus configured for operation in a wireless communication network, the apparatus comprising:
a memory; and
at least one processor coupled to memory, the at least one processor being configured:
to determine a periodicity of pilot signals of a non-serving radio access technology (RAT);
to determine a time offset between a subframe of a serving RAT and a pilot signal of the non-serving RAT based at least in part on the periodicity;
to determine measurement gap groups for user equipments (UEs) to measure the pilot signals of the non-serving RAT based at least in part on the time offset; and
to allocate UEs to measurement gap groups.

17. The apparatus of claim 16, in which the at least one processor is further configured:
to divide the measurement gap groups into even numbered groups and odd numbered groups; and
to allocate UEs to alternating measurement gap groups starting with the even numbered groups.

18. The apparatus of claim 16, in which the at least one processor is configured to determine the measurement gap groups further based on the measurement gap periodicity of the serving RAT.

19. The apparatus of claim 16, in which the at least one processor is further configured to align measurement gap groups with subframe boundaries of the serving RAT.

20. The apparatus of claim 19, in which the at least one processor is configured to align measurement gap groups further based at least in part on a time for a UE to tune from the serving RAT to the non-serving RAT.
